(19) United States
(12) Patent Application Publication
(10) Pub. No.: US 2008/0037031 A1
(43) Pub. Date: Feb. 14, 2008

(54) Terahertz Time Domain Sensing to Derive Physical Characteristics of an Object by Evaluating the Contribution of Surface Waves to the Reflected/Scattered Time Domain Waveform

(76) Inventors: Bryan E. Cole, Cambridge (GB); Julian A. Cluff, Cambridge (GB)

Correspondence Address: DICKSTEIN SHAPIRO LLP, 1825 EYE STREET NW, Washington, DC, 20006-5403, US

(21) Appl. No.: 11/632,503

(22) PCT Filed: Jul. 8, 2005
(86) PCT No.: PCT/GB05/02710

§ 371 Date: Mar. 27, 2007

(30) Foreign Application Priority Data
Jul. 16, 2004 (EP) 0416015.6

(51) Int. Cl. G01N 21/41; G01B 11/00; G01B 11/06

(52) U.S. Cl. 356/601; 356/625; 356/632

(57) ABSTRACT

The present invention provides a method of analysing an object (29) (for example a wive or a steut), comprising the steps of: (a) irradiating the object with a Terahertz pulse of electromagnetic radiation, such that a portion of the irradiating radiation couples to the object as a surface wave; (b) detecting radiation reflected and/or scattered from the object to obtain a time domain waveform; (c) extracting the parts of the radiation detected in step (b) relating to the surface wave on the object and (d) analysing the radiation identified in step (c) in order to derive information relating to a physical characteristic (for example the thickness of a coating) of the object.

The present invention relates generally to the field of apparatus and methods for imaging and/or investigating samples in the far-infrared (far-IR)/Terahertz (THz) frequency range. More specifically, the present invention relates to investigating a sample using radiation in the far-infrared/Terahertz frequency range from 100 GHz to 100 THz. Preferably the radiation utilised is in the frequency range of 500 GHz to 100 THz and more preferably from 1 THz to 100 THz and most preferably from 700 GHz to 10 THz.

Recently, there has been much interest in using THz radiation to look at a wide variety of samples using a range of methods. THz radiation has been used for both imaging samples and obtaining spectra. Recently, work by Mittleman et al, IEEE Journal of Selected Topics in Quantum Electronics, Vol. 2, No. 3, September 1996, page 679 to 692 illustrates the use of using THz radiation to image various objects such as a flame, a leaf, a moulded piece of plastic and semiconductors.

THz radiation penetrates most dry, non metallic and non polar objects like plastics, paper, cardboard and non polar organic substances. Therefore, THz radiation can be used instead of x-rays to look inside boxes, cases etc. THz has lower energy, non-ionising photons than X-rays, hence, the health risks of using THz radiation are expected to be vastly reduced compared to those using conventional X-rays.

Terahertz Time Domain Spectroscopy (TDS) has been used in the topographic measurement of relatively thick objects (see for example Mittleman et al, Opt. Lett. 22, 904 (1997)) and various differential and interferometric techniques have been developed to investigate the metrology of thin films (see Jiang, Li and Zhang, Appl. Phys. Lett 76, 3221 (2000) and Johnson, Dorney and Mittleman, Appl Phys Lett. 78, 835 (2001)).

However, these techniques are complex and are also only capable of sensing differences between a test piece and a reference.

It is therefore an aim of the present invention to overcome or alleviate problems associated with the prior art.

According to one aspect the present invention provides a method of analysing an object, comprising the steps of: (a) irradiating the object with a pulse of electromagnetic radiation, said pulse having a plurality of frequencies in the range from 100 GHz to 100 THz, such that a portion of the irradiating radiation couples to the object as a surface wave; (b) detecting radiation reflected and/or scattered from the object to obtain a time domain waveform; (c) extracting the parts of the radiation detected in step (b) relating to the surface wave on the object and (d) analysing the radiation identified in step (c) in order to derive information relating to a physical characteristic of the object.

The above aspect of the present invention recognises that radiation will scatter around target objects as well as directly reflecting from them and that this scattered radiation can be used to derive information about the target.

Scattering is well described by Mie theory and this theory has been used to explain the optical effects of rainbows and also the “glory” effect observed when light scatters from water droplets in the atmosphere (Glory results in light being scattered in a backwards direction and appears as concentric rings of light when the suspended water droplets are illuminated from behind the observer).

According to the method of the present invention an object is illuminated by a pulse of radiation. Some of this radiation is directly reflected from the object but some will effectively couple to the surface of the object. This surface wave radiation, from the point of view of the source of the radiation, passes around the back of the object before being scattered from the object and detected along with the directly reflected radiation.

If the illuminating radiation wavelength is of the order of the size of the object being investigated it is difficult to resolve features on the object since they will inevitably be smaller than the radiation wavelength. The present invention however realises that radiation that couples to the surface as a surface wave will have a greater interaction length with these features thereby allowing them to be investigated. For example, consider a particle of diameter d, the particle being coated with a material of thickness x (where x<d). Radiation that directly reflects from the object will only interact with the coating over an interaction distance of 2x. Since the wavelength ˜d then these features will not be resolvable.

However, radiation that couples to the surface interacts over an interaction length of πd (the circumference of the object). This increased interaction distance allows features of the object to be investigated even if those features are of sub-wavelength dimensions.

The surface wave scattered radiation detected in the method of the present invention is extracted from the detected signal in the time domain. Analysis of this portion of the detected radiation allows physical characteristics of the object to be investigated.

The phase and/or amplitude of the scattered portion of the detected radiation may conveniently be monitored. Any changes in these properties can be related to physical characteristics such as thickness of a coating material, surface roughness or potentially refractive index of the object.

Conveniently, the portion of the detected radiation that results from directly reflected (specular radiation) can be extracted. The time difference between the reflected and scattered radiation therefore provides a convenient way to monitor changes in the phase and/or amplitude of the detected radiation.

The method according to the present invention is particularly suited to characterising the thickness of a coating material that overlays the object under investigation.

When the method of the present invention is used to analyse conducting objects that extend substantially in a single dimension (e.g. wires) it is preferable if the electrical component of the illuminating radiation is orthogonal to the long axis of the object. The technique of the present invention has particular application to the investigation of drug-eluting stents.

Recent advances in medical technology have led to the creation of the “stent”, a stainless steel wire mesh tube designed to prop open an artery that has recently been cleared using angioplasty. In use the stent is collapsed to a small diameter and put over a balloon catheter. It is then moved into the area of the blockage and the balloon is inflated whereupon the stent expands, locks in place and forms a scaffold in order to hold the artery open.

Once in place a stent will stay in the artery permanently, holding it open and improving blood flow to the heart muscle and relieving symptoms (usually chest pain). The stent is intended to reduce the re-narrowing that may occur after balloon angioplasty or other procedures that use catheters.

However stented arteries can reclose and so in recent years doctors have used new types of stents called drug-eluting stents. These are coated with drugs that are slowly released and help keep the blood vessel from reclosing. These new stents have shown some promise for improving the long-term success of this procedure. There is a need within the medical industry to assess, non-destructively, the amount and potency of a drug coating administered to a stent. These coatings are typically of the order 2-10 μm and stents are generally of the order of 100 μm in diameter.

It is therefore possible to characterise the coating of drug eluting stents by utilising the method of the present invention. Features such as thickness of the drug coating can be derived thereby providing a means of non-destructively assessing the coating administered to stents.

For objects such as wires or stents (which are effectively wire-like in shape) it is preferable to raster scan the illuminating radiation over the entire surface area of the object either by moving the source/detector or by rotating the object.

Conveniently, the object can be rotated through the illuminating radiation in a helical manner in order to scan the whole surface.

The method of the present invention may further comprises the step of Fourier transforming the scattered radiation in order to derive spectral information about the composition of the object.

In a second aspect of the present invention there is provided a method of analysing an object comprising a central portion and a coating layer overlying the central portion comprising the steps of (a) irradiating the object with a pulse of electromagnetic radiation, said pulse having a plurality of frequencies in the range from 100 GHz to 100 THz, such that a portion of the irradiating radiation couples to the object as a surface wave; (b) detecting radiation reflected and/or scattered from the object to obtain a time domain waveform; (c) extracting the parts of the radiation detected in step (b) relating to the surface wave on the object and (d) analysing the radiation identified in step (c) in order to derive the thickness of the coating layer.

In a third aspect of the present invention there is provided an apparatus for investigating a stent, the stent comprising a substantially cylindrical mesh structure, comprising (a) a source of electromagnetic radiation for irradiating the stent with a pulse of electromagnetic radiation, said pulse having a plurality of frequencies in the range from 100 GHz to 100 THz, such that a portion of the irradiating radiation couples to the stent as a surface wave; (b) a detector for detecting radiation reflected and/or scattered from the stent to obtain a time domain waveform; (c) means for extracting the parts of the radiation detected in step (b) relating to the surface wave on the object; (d) means for analysing the radiation identified in step (c) in order to determine the presence of a coating layer on the stent; (e) means for raster scanning the irradiating pulse of radiation over the surface area of the stent.

In a fourth aspect of the present invention there is provided an apparatus for investigating a stent, the stent comprising a layer of drug material overlying a substantially cylindrical mesh structure and the apparatus comprising (a) a source of electromagnetic radiation for irradiating the stent with a pulse of electromagnetic radiation, said pulse having a plurality of frequencies in the range from 100 GHz to 100 THz, such that a portion of the irradiating radiation couples to the stent as a surface wave; (b) a detector for detecting radiation reflected and/or scattered from the stent to obtain a time domain waveform; (c) means for extracting the parts of the radiation detected in step (b) relating to the surface wave on the object; (d) means for analysing the radiation identified in step (c) in order to determine the thickness of the coating layer on the stent and; (e) means for raster scanning the irradiating pulse of radiation over the cylindrical surface area of the stent.

The present invention will now be described with reference to the accompanying drawings in which:

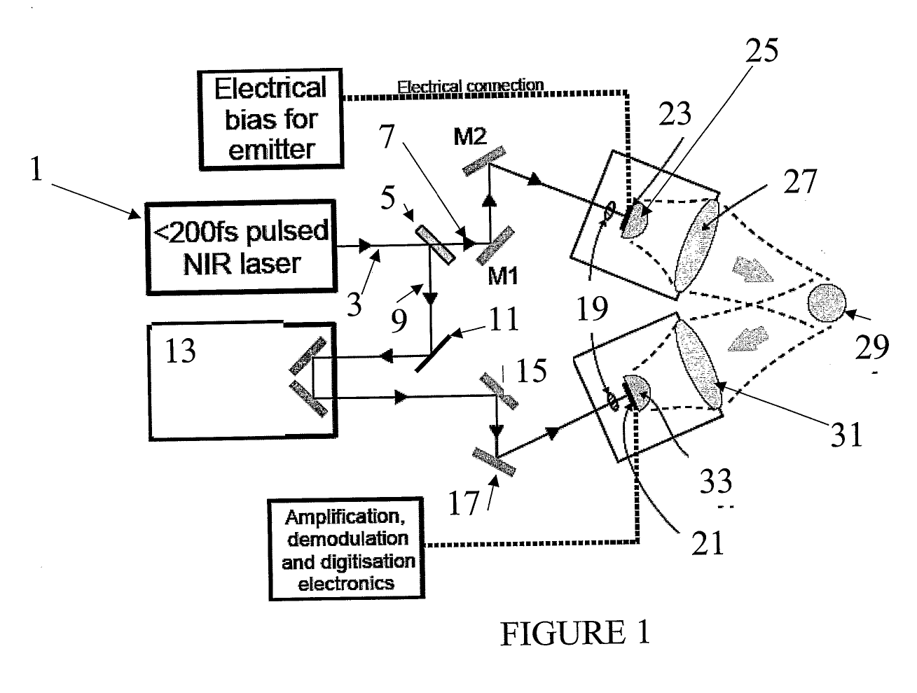

FIG. 1 illustrates a schematic of a pulsed terahertz reflection investigative technique utilised in the present invention;

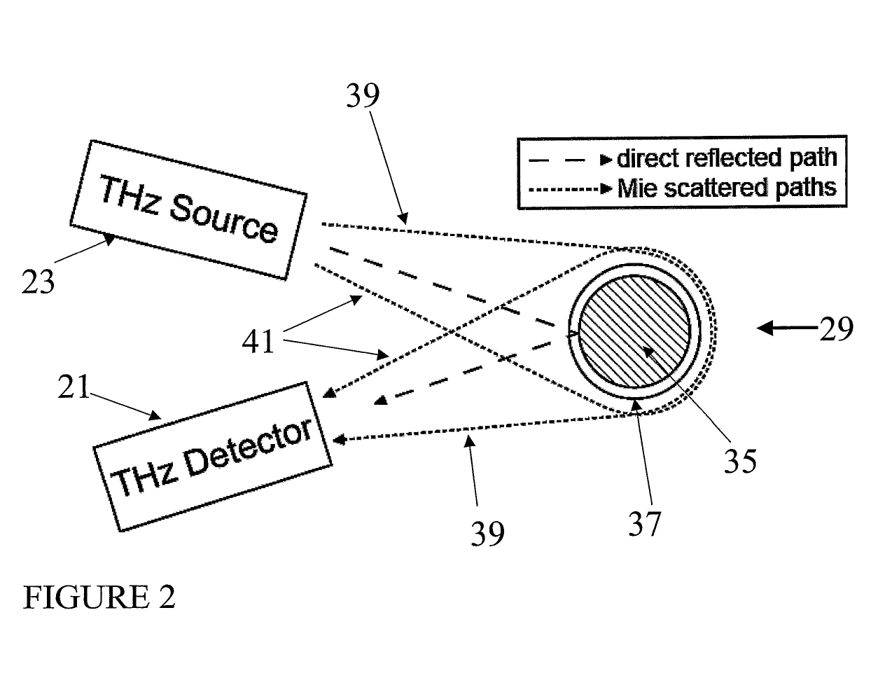

FIG. 2 illustrates the wave paths taken by radiation reflecting from or scattering from the object shown in FIG. 1.

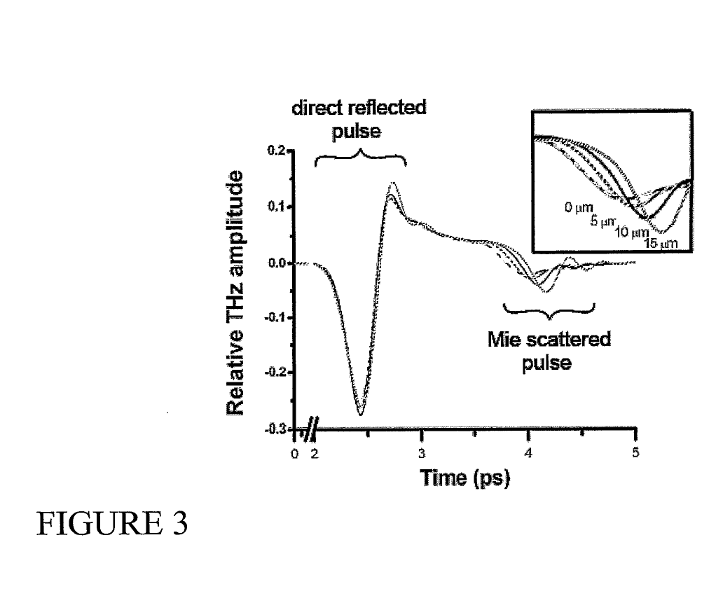

FIG. 3 time domain waveforms of radiation reflecting/scattering from a cylindrical object for varying coating thicknesses

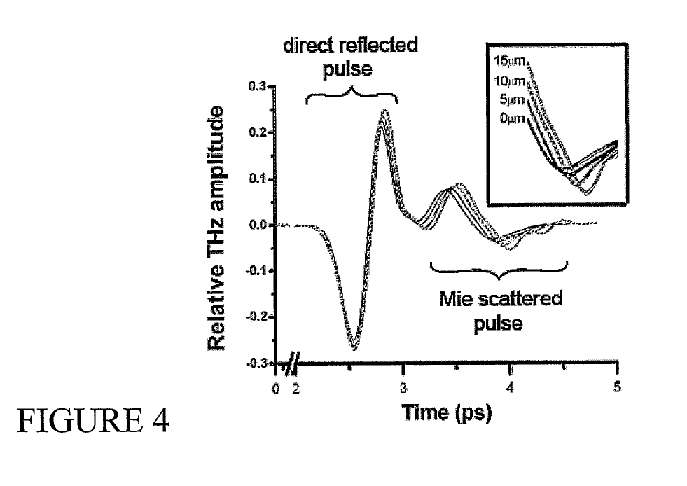

FIG. 4 time domain waveforms of radiation reflecting/scattering from an object or rectangular cross section for varying coating thicknesses

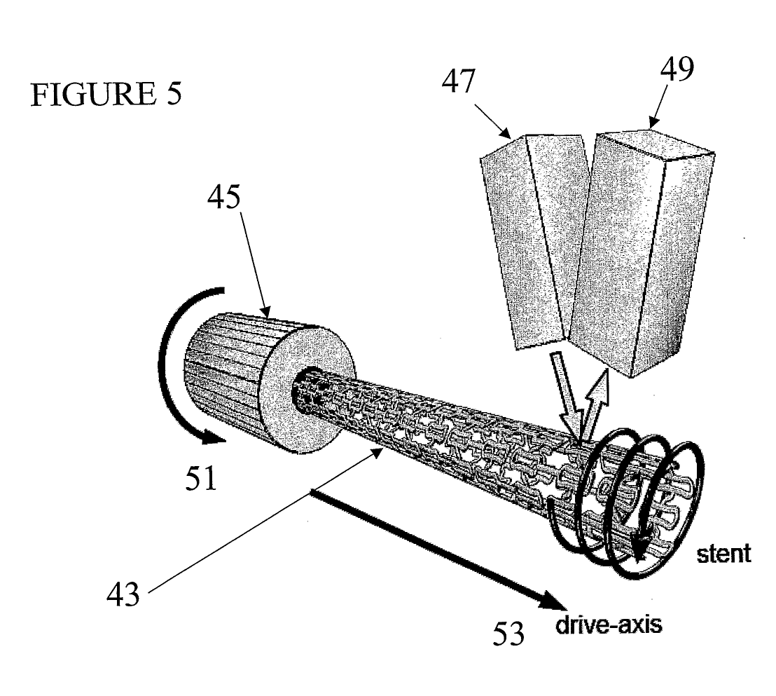

FIG. 5 illustrates a method of imaging the coating on a pharmaceutical stent.

Referring to FIG. 1, a terahertz pulsed investigating arrangement is illustrated, which comprises an ultra-short pulse NIR laser 1 which may be, for example, Ti:sapphire, Yb:Er doped fibre, Cr:LiSAF, Yb:silica, Nd:YLF, Nd:Glass, Nd:YAG, Alexandrite Yb:Phosphate Glass QX, Yb:GdCOB, Yb:YAG, Yb:KG d(WO₄) or Yb:BOYS laser. This laser 1 emits pulses of radiation 3, such as a collimated beam of pulses, each of which comprise a plurality of frequencies. The pulses generated by the laser preferably having a pulse duration of less than 200 fs.

The beam of generated pulses is directed into beam splitter 5. The beam splitter splits the beam into a pump beam 7, which is used to irradiate the sample, and a probe beam 9, which is used during detection.

The probe beam 9 is directed, via plain mirror 11, into scanning delay line 13. Scanning delay line 13 is a variable optical delay, which in its simplest form comprises two mirrors that serve to reflect the beam through a 180° angle. Using a computer as a controller, these mirrors can be quickly swept backwards and forwards in order to vary the path length of the probe beam 9. In this way the scanning delay line 13 assists in matching the relative path lengths of the pump and probe beams. The probe beam is then directed by mirrors 15 and 17 into a NIR lens 19 which focussed the probe beam onto receiver 21 for combining with the Terahertz beam.

The pump beam 7 is directed onto a source 23. For pulsed approaches this source 23 preferably comprises a GaAs based photoconductive switch. GasAs based devices use the principle of photoconductive modulation to generate their THz output.

The radiation emitted by the emitter 23 is directed via a hyper-hemispherical lens 25 into a polythene lens 27 which focuses the THz beam onto sample 29.

To analyse a particular sample in situ, the sample 29 may be moved relative to the beam of radiation through the focal plane of the THz beam or the beam may be moved relative to the sample or both.

The THz radiation that is reflected and/or scattered from sample 29 is received by the detector 21. The detector may, for example, be an electro-optic detector or a photoconductive detector.

Photoconductive detectors comprise a detection member which may be, for example, LT-GaAs, LT-InGaAs, As-implanted GaAs, As-implanted InGaAs or Si on Sapphire etc. The detection member 21 is used to detect both the amplitude and phase of the radiation emitted from the sample 29. The reflected and scattered radiation passes through another polythene lens 31 and is collected by a silicon lens 33, which may be hemispherical or have another shape.

FIG. 2 illustrates the various wave paths for radiation that is scattered and reflected from the sample 29 in FIG. 1 above. Like reference numerals are used to denote like features.

It can be seen that in the case depicted in FIG. 2 the sample 29 comprises a central body 35 which is coated with a material 37.

Radiation from the source 23 can either specularly reflect (dashed line) from the sample 29 to the detector 21 or can scatter (dotted line) to the detector.

Radiation from the source which impinges tangentially on the sample 29 can couple to the sample surface as what is known as a surface or creep wave. As can be seen from the Figure radiation that couples to the surface in this way can reach the detector 21 by more than one path. Path 39 corresponds to radiation that has traveled in a clockwise direction around the sample 29 and has then scattered from the surface to reach the detector 21. Path 41 corresponds to radiation that has traveled in an anti-clockwise direction around the sample 29.

The scattering effect described above is known as Mie scattering and occurs when the wavelength of the irradiating radiation is of the same order as the scattering centre's diameter.

By detecting this “Mie” scattered radiation it is possible to determine features on the sample that would not normally be possible.

FIG. 3 shows the waveforms detected from a 150 micron diameter wire (i.e. a cylindrical sample) with a coating of varying thickness. The wire was copper and the coating had a refractive index of approximately 1.5 (n≈1.5). The coating on the wire was varied in 5 micron increments from 0 to 15 microns. The irradiating wave was a Gaussian pulse whose bandwidth in the frequency domain had a full width half maximum at 3 THz. The incident radiation was polarised with its electric filed orthogonal to the long axis of the wire. Detected radiation was received by a detector located approximately 200 microns from the wire.

Radiation that is specularly and directly reflected from the coated wire appears at time t≈2.5 ps. It can be seen that there is little change in the amplitude or phase of this directly reflected pulse as the coating thickness is varied from 0-15 microns.

The scattered pulse appears at t≈4 ps. Increasing coating thickness results in an increase in the relative time separation between the directly reflected pulse and the scattered pulse.

The cylindrical sample above was changed for a sample with a rectangular cross section. A coating of varying thickness was once again applied to the sample and the results/waveforms (for the rectangular sample) are shown in FIG. 4. It can be seen once again that the thickness of the coating has little effect on the directly reflected pulse but that increasing the thickness of the coating increases the separation of the directly reflected pulse and the scattered pulse.

FIG. 5 shows an arrangement for investigating the coating of a drug eluting stent. A stent 43 is held in a clamp 45. A THz emitter and detector (47 and 49) are arranged such that the surface of the stent can be irradiated with THz radiation from the emitter and the reflected and scattered radiation can be collected by the detector. The emitter and detector are located on a line parallel to the long axis of the stent

The stent is rotated about its axis as indicated by arrow 51 and is also simultaneously linearly translated along its long axis (as indicated by arrow 53). The stent is therefore driven in a helical manner.

The scattered radiation is analysed according to a method of the present invention in order to derive information (e.g. thickness) of the drug coating on the stent. By rotating the stent as indicated the entire surface of the stent can be scanned.

The stent is clamped at one end only in order to minimise the area occluded by the clamping means.

Once scattered radiation has been isolated from the detected radiation it is also possible to derive spectral components of the coating by Fourier transforming the time domain signal in order to obtain a spectral trace in the frequency domain.

1. A method of analysing an object, comprising the steps of:
a) irradiating the object with a pulse of electromagnetic radiation, said pulse having a plurality of frequencies in the range from 100 GHz to 100 THz, such that a portion of the irradiating radiation couples to the object as a surface wave;
b) detecting radiation reflected and/or scattered from the object to obtain a time domain waveform;
c) extracting the parts of the radiation detected in step (b) relating to the surface wave on the object; and
d) analysing the radiation identified in step (c) in order to derive information relating to a physical characteristic of the object.

2. The method of claim 1 further comprising the step of identifying the parts of the radiation detected in step (b) which are due to specular reflection from the object.

3. The method of claim 1 wherein the analysis in step (d) is performed in the time domain.

4. The method of claim 3 wherein the information relating to the object is derived from the phase and/or amplitude of the radiation detected in step (c).

5. The method of claim 2 wherein the phase and amplitude of the radiation derived in step (c) is compared to the phase and/or amplitude of the specularly reflected radiation.

6. The method of claim 1 wherein the object comprises a central portion and a coating layer overlying the central portion and the physical characteristic that is derived is the thickness of the coating layer.

7. The method of claim 1 wherein the object substantially extends in one dimension.

8. The method of claim 7 wherein the object is conducting and the electrical component of the irradiating radiation is orthogonal to the axis of the object.

9. The method of claim 1 wherein the object is a drug eluting stent.

10. The method of claim 7 wherein the irradiating radiation is raster scanned by rotating the object in a helical manner through the pulse of irradiating radiation.

11. The method of claim 1 further comprising the step of deriving spectral information by performing a Fourier transform on the radiation derived in step (c).

12. A method of analysing an object comprising a central portion and a coating layer overlying the central portion comprising the steps of
a) irradiating the object with a pulse of electromagnetic radiation, said pulse having a plurality of frequencies in the range from 100 GHz to 100 THz, such that a portion of the irradiating radiation couples to the object as a surface wave;
b) detecting radiation reflected and/or scattered from the object to obtain a time domain waveform;
c) extracting the parts of the radiation detected in step (b) relating to the surface wave on the object; and
d) analysing the radiation identified in step (c) in order to derive the thickness of the coating layer.

13. An apparatus for investigating a stent, the stent comprising a substantially cylindrical mesh structure and the apparatus comprising
a) a source of electromagnetic radiation for irradiating the stent with a pulse of electromagnetic radiation, said pulse having a plurality of frequencies in the range from 100 GHz to 100 THz, such that a portion of the irradiating radiation couples to the stent as a surface wave;
b) a detector for detecting radiation reflected and/or scattered from the stent to obtain a time domain waveform;
c) means for extracting the parts of the radiation detected in step (b) relating to the surface wave on the object;
d) means for analysing the radiation identified in step (c) in order to determine the presence of a coating layer on the stent;
e) means for raster scanning the irradiating pulse of radiation over the cylindrical surface area of the stent.

14. An apparatus for investigating a stent, the stent comprising a layer of drug material overlying a substantially cylindrical mesh structure and the apparatus comprising
a) a source of electromagnetic radiation for irradiating the stent with a pulse of electromagnetic radiation, said pulse having a plurality of frequencies in the range from 100 GHz to 100 THz, such that a portion of the irradiating radiation couples to the stent as a surface wave;
b) a detector for detecting radiation reflected and/or scattered from the stent to obtain a time domain waveform;
c) means for extracting the parts of the radiation detected in step (b) relating to the surface wave on the object;
d) means for analysing the radiation identified in step (c) in order to determine the thickness of the coating layer on the stent;
e) means for raster scanning the irradiating pulse of radiation over the cylindrical surface area of the stent.

15. The apparatus of claim 13 wherein the means for raster scanning comprises means for rotating the stent about its cylindrical axis and translating the stent in a direction parallel to the cylindrical axis such that the stent moves in a helical manner through the pulse of irradiating radiation.

16. The apparatus of claim 14 wherein the means for raster scanning comprises means for rotating the stent about its cylindrical axis and translating the stent in a direction parallel to the cylindrical axis such that the stent moves in a helical manner through the pulse of irradiating radiation.

17. (canceled)
